(19) United States
(12) Patent Application Publication
(10) Pub. No.: US 2017/0355242 A1
(43) Pub. Date: Dec. 14, 2017

(54) METHOD FOR OPERATING A MOTOR VEHICLE

(71) Applicant: Dr. Ing. h.c. F. Porsche Aktiengesellschaft, Stuttgart (DE)

(72) Inventor: Andreas Munzert, Gerlingen (DE)

(73) Assignee: Dr. Ing. h.c. F. Porsche Aktiengesellschaft, Stuttgart (DE)

(21) Appl. No.: 15/618,390

(22) Filed: Jun. 9, 2017

(30) Foreign Application Priority Data
Jun. 14, 2016 (DE) 102016110851.0

(51) Int. Cl. B60G 17/016

(52) U.S. Cl. CPC B60G 17/0162; B60G 2500/40; B60G 2800/214

(57) ABSTRACT

A method for operating a motor vehicle which includes an active chassis system with which it is possible to change a wheel load distribution between two rear wheels and two front wheels which are deflected relative to a supporting structure of the motor vehicle by a steering system during a maneuvering process, wherein friction occurs at the front wheels owing to ground contact. In order to prevent the occurrence of undesired noise during the maneuvering, during the maneuvering process with the large wheel deflection, the wheel load at a first wheel pair, which comprises a left/right front wheel and a right/left rear wheel arranged diagonally with respect thereto, is reduced selectively compared to a second wheel pair, which comprises a right/left front wheel and a left/right rear wheel arranged diagonally with respect thereto, in order to reduce the friction at one of the two front wheels during the maneuvering.

### CROSS-REFERENCE TO RELATED APPLICATION

This application claims priority to German Patent Application No. 102016110851.0, filed Jun. 14, 2016, the content of such application being incorporated by reference herein in its entirety.

### FIELD OF THE INVENTION

The invention relates to a method for operating a motor vehicle which comprises a chassis with an active chassis system with which it is possible to change a wheel load distribution between two rear wheels and two front wheels which are deflected to a large extent relative to a supporting structure of the motor vehicle by means of a steering system during a maneuvering process, wherein friction occurs at the front wheels owing to ground contact.

### BACKGROUND OF THE INVENTION

European laid-open patent application EP 0 992 373 A2, which is incorporated by reference herein, discloses a method for shortening the braking distance and improving the traction of a motor vehicle which has a roll-stabilization system with at least one actuator drive on at least one axle, which actuator drive is arranged between the two halves of a chassis stabilizer, wherein the actuator drives on the axles are tensioned diagonally in the same direction so that contact forces of the wheels are increased or decreased according to different measured coefficients of friction, in order to permit shortening of the braking distance and improvement of the traction using the roll-stabilization system in the case of road surfaces which have different degrees of grip on the left-hand side and the right-hand side. German laid-open patent application DE 10 2008 048 222 A1, which is incorporated by reference herein, discloses a steering device for adjusting a wheel deflection angle of at least one rear wheel on a motor vehicle, wherein the steering device is actuated in such a way that it sets a toe-in or a toe-out on at least one wheel of the rear axle.

German laid-open patent application DE 40 15 974 A1, which is incorporated by reference herein, discloses a steerable motor vehicle rear axle with rigid lateral longitudinal links which support non-steerable wheels and are coupled in an articulated fashion by their front ends, which are remote from the wheels, in a pivotable fashion on the vehicle body by means of rubber-elastic bearings and are connected to one another by means of a transverse strut which acts in each case on said longitudinal links in a dimensionally rigid fashion and can be twisted about their longitudinal axis, wherein, by means of an actuator element which can pivot the longitudinal links, it is possible to generate a steering movement of the wheels which is either in the opposite direction or in the same direction with respect to the steering movement of the front wheels, as a function of operating parameters of the vehicle.

German laid-open patent application DE 10 2008 003 901 A1, which is incorporated by reference herein, discloses a method for setting the wheel loads on a two-track, two-axle motor vehicle which is provided with a suitable system for changing the wheel load distribution, in particular using what are referred to as active stabilizers, wherein in the is case of different coefficients of friction on the two vehicle sides, the vehicle axles are tensioned in opposite directions in that, on the first axle, the vertical load of the wheel is increased on the first vehicle side, and the vertical load of the wheel is decreased on the second vehicle side, while on the second axle the vertical load of the wheel is decreased on the first vehicle side, and the vertical load of the wheel is increased on the second vehicle side.

### SUMMARY OF THE INVENTION

It would be desirable to prevent the occurrence of undesired noise during the maneuvering, in particular during the parking or exiting of a parking space, by a motor vehicle which comprises a chassis with an active chassis system with which it is possible to change a wheel load distribution between two rear wheels and two front wheels which are deflected to a large extent relative to a supporting structure of the motor vehicle by means of a steering system during a maneuvering process, wherein friction occurs at the front wheels owing to ground contact.

Described herein is a method for operating a motor vehicle which comprises an active chassis system with which it is possible to change a wheel load distribution between two rear wheels and two front wheels which are deflected to a large extent relative to a supporting structure of the motor vehicle by means of a steering system during a maneuvering process, wherein friction occurs at the front wheels owing to ground contact, in that during the maneuvering process with the large wheel deflection, the wheel load at a first wheel pair, which comprises a left/right front wheel and a right/left rear wheel arranged diagonally with respect thereto, is reduced selectively compared to a second wheel pair, which comprises a right/left front wheel and a left/right rear wheel arranged diagonally with respect thereto, in order to reduce the friction at one of the two front wheels during the maneuvering. The maneuvering process is preferably a parking process, that is to say a process of parking the motor vehicle or exiting a parking space with the motor vehicle.

A large wheel deflection is understood to be deflection, in particular maximum deflection, of the steering system such as is carried out, for example, when parking in a parking space or when maneuvering into a parking bay. The reduction in the wheel load of the first wheel pair with the two diagonally arranged wheels is also referred to as a reduction in the diagonal wheel load. The front wheel with the reduced wheel load during the maneuvering is preferably a front inside wheel. The front wheel of the first wheel pair produces less cornering force during the maneuvering owing to the reduced wheel load. This ensures that the front wheel of the first wheel pair which is loaded less can skid or slip with significantly less generation of noise during the maneuvering. As a result, undesired jumping of the front inside wheel which is loaded less is particularly advantageously prevented during the maneuvering.

One preferred exemplary embodiment of the method is wherein the chassis is interlocked diagonally in order to generate cross-load shifting. The cross-load shifting causes a first wheel pair to be relieved of loading and the second wheel pair to be loaded to a greater extent than before. The cross-load shifting is preferably achieved by means of actuator elements of the active chassis system.

A further preferred exemplary embodiment of the method is wherein during the maneuvering a front inside wheel is forced by the wheel load, which is reduced compared to a front outside wheel, onto a circular path which is concentric with respect to a circular path of the front outside wheel. This advantageously ensures that a turning circle of the motor vehicle during the maneuvering is determined only by the front outside wheel. The front inside wheel follows the forced circular path which is concentric with respect to the circular path of the front outside wheel.

A further preferred exemplary embodiment of the method is wherein during the maneuvering a turning circle of the motor vehicle is reduced significantly owing to the forced circular path of the front inside wheel. The turning circle of the motor vehicle during the maneuvering can, for example, be advantageously reduced by a meter. Further changes to the chassis of the motor vehicle are not necessary to reduce the turning circle of the motor vehicle.

A further preferred exemplary embodiment of the method is wherein during the maneuvering a real deflection angle of the front inside wheel is reduced compared to an ideal deflection angle at which the front wheels describe concentric circular paths in the case of an Ackermann percentage of one hundred percent. Clean rolling of the wheels is ideally achieved if steering cinematics satisfy what is referred to as the Ackermann condition. This means that prolongations of the wheel axles of the steered front wheels intersect at a common point with a prolongation of the wheel axle of the non-steered rear wheels. If the Ackermann condition is completely satisfied it corresponds to an Ackermann percentage of one hundred percent.

A further preferred exemplary embodiment of the method is wherein the active chassis system is actuated in such a way that the chassis is interlocked and the wheel load of the second diagonal wheel pair is increased in order to reduce the wheel load of the first diagonal wheel pair. This ensures that the front wheel of the first wheel pair has a lower wheel load and can therefore skid or slip more easily and with less noise. As a result of the reduced wheel load, tire friction effects between a tire of the front wheel with the reduced wheel load and the ground are reduced.

Also described herein is an active chassis system for operating a motor vehicle according to a method described above. The active chassis system advantageously comprises active actuators for changing the wheel load distribution during the maneuvering.

Also described herein is a computer program product having a program code for carrying out a method described above. The computer program is run, for example, in a control unit of the motor vehicle, by means of which computer program the active chassis system described above is actuated during the maneuvering.

Also described herein is a control unit for controlling an active chassis system with a computer program product described above.

Also described herein is a motor vehicle having a chassis system described above and/or having a control unit described above.

### BRIEF DESCRIPTION OF THE DRAWING FIGURES

Further advantages, features and details of the invention can be found in the following description in which various exemplary embodiments are described in detail with reference to the drawing, in which:

FIG. 1 shows a simplified illustration of a motor vehicle having a chassis which comprises two front wheels and two rear wheels, and having an active chassis system, wherein the two front wheels describe concentric circular paths in the case of an Ackermann percentage of one hundred percent;

FIG. 2 shows the same illustration as in FIG. 1, wherein an inside front wheel experiences less deflection to a large extent in the case of an Ackermann percentage which is less than one hundred percent; and

FIG. 3 shows a similar illustration to that in FIG. 2, wherein the inside front wheel is forced by the active chassis system onto a circular path which is concentric with respect to the circular path of the outside front wheel.

### DETAILED DESCRIPTION OF THE INVENTION

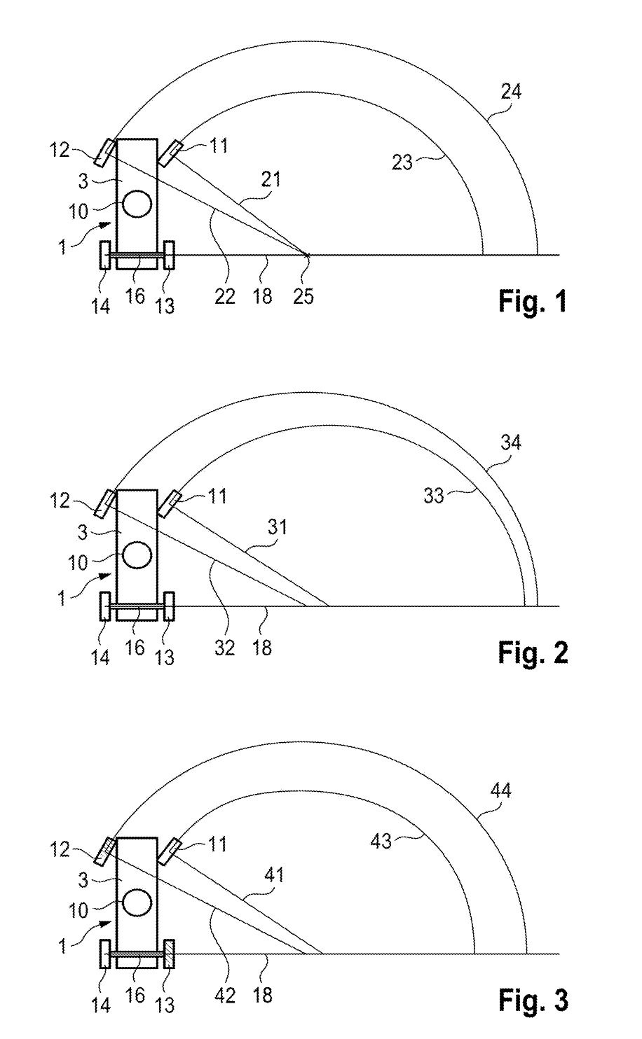

FIGS. 1 to 3 are highly simplified illustrations of a motor vehicle 1 with a chassis 3. The chassis 3 comprises two steerable front wheels 11, 12 and two non-steerable rear wheels 13, 14.

The motor vehicle 1 also comprises an active chassis system 10. The active chassis system 10 in turn comprises active actuator elements (not illustrated) with which it is possible to change a wheel load distribution between the wheels 11 to 14 of the chassis 3.

The rear wheels 13, 14 are rotatable about a rear axle 16. In FIGS. 1 to 3, a line 18 extends as a prolongation of the rear axle 16 of the motor vehicle 1.

In FIGS. 1 to 3, the front wheels 11, 12 of the motor vehicle 1 are deflected to the right to large extent, in particular to a maximum extent, for the purpose of maneuvering, in particular for the purpose of parking or exiting a parking space. In the illustrated plan view, the front wheels 11, 12 here are pivoted to the right relative to a vehicle longitudinal axis.

In FIG. 1, the inside front wheel 11 describes a circular path 23. A prolongation of a wheel axle of the inside front wheel 11 is indicated by a line 21. The outside front wheel 12 describes a circular path 24. A prolongation of a wheel axle of the outside front wheel 12 is indicated by a line 22.

The two circular arcs 23 and 24 are concentric, and the two lines 21, 22 of the circular paths 23, 24 intersect at a point 25. The intersection point 25 of the lines 21, 22 lies on the line 18.

Accordingly, in FIG. 1 what is referred to as the Ackermann condition is completely satisfied, said condition requiring the prolongations 21, 22 of the wheel axles of the steered wheels 11, 12 to intersect at the same point 25 on the prolongation 18 of the wheel axle 16 of the non-steered wheels 13, 14.

Since the two front wheels 11, 12 in FIG. 1 describe concentric circular paths 23, 24 in the case of an Ackermann percentage of one hundred percent, perfect rolling of the front wheels 11, 12 without skewing is possible. However, FIG. 1 shows that the inside front wheel 11 must be deflected to such a large extent for this purpose that it collides with the chassis 3, in particular with a bodywork longitudinal carrier of the vehicle body.

FIG. 1 illustrates that in practice, in particular when wheels with broad tires are used, an Ackermann percentage of one hundred percent is never reached. An Ackermann percentage of one hundred percent is also otherwise not desired for other vehicle movement dynamics reasons.

In FIG. 2, the inside front wheel 11 describes a circular path 33. A prolongation of a wheel axle of the inside front wheel 11 is indicated by a line 31. The outside front wheel 12 describes a circular path 34. A prolongation of a wheel axle of the outside front wheel 12 is indicated by a line 32. The lines 31, 32 intercept the line 18 as a prolongation of the rear axle 16 at various points.

FIG. 2 illustrates that the inside front wheel 11 is deflected to a large extent less in the case of an Ackermann percentage which is less than one hundred percent, and therefore moves freely with respect to the vehicle body. However, the two front wheels 11, 12 then no longer describe concentric circular paths.

If the motor vehicle 1 in FIG. 1 moves around a bend, the tires run obliquely because they maintain a fixed distance from one another owing to their suspension in the chassis 3. Therefore the wheel which has less cornering force, generally the outside front wheel 12, skids or slips.

This wheel, in particular, the outside front wheel 12, is therefore forced into a circle which is concentric with respect to the other wheel, in particular with respect to the inside front wheel 11. This leads to a situation in which, depending on the underlying surface, undesired noise occurs, for example squeaking in a multistory car park, or even jumping of a wheel, which is also referred to as parking judder.

In FIG. 3, the inside front wheel 11 moves on a circular path 43. A prolongation of a wheel axle of the inside front wheel 11 is indicated by a line 41. The outside front wheel 12 moves on a circular path 44. A prolongation of a wheel axle of the outside front wheel 12 is indicated by a line 42. The two circular paths 43 and 44 in FIG. 3 are concentric.

FIG. 3 illustrates how the right-hand inside front wheel 11 and the left-hand outside rear wheel 14 are relieved of loading by cross-pivoting of the axle of the motor vehicle 1. This has the effect that the inside front wheel 11 can produce less cornering force and slips with reduced generation of noise and inclination to judder.

As a result, the right-hand inside front wheel 11 is in turn forced onto the circular path 43. The prolongations 41, 42 of the wheel axles of the front wheels 11, 12 do not have a common intersection point with the line 18 in a prolongation of the rear axle 16. The Ackermann condition is therefore not completely satisfied in FIG. 3.

Since the inside front wheel 11 slips in FIG. 3, a turning circle of the motor vehicle 1 is now determined only by the outside front wheel 12. As a result, the turning circle of the motor vehicle 1 as a secondary effect is reduced by approximately one meter.

What is claimed is:

1. A method for operating a motor vehicle which comprises a chassis with an active chassis system with which it is possible to change a wheel load distribution between two rear wheels and two front wheels, which are deflected to a large extent relative to a supporting structure of the motor vehicle by a steering system during a maneuvering process, wherein friction occurs at the front wheels owing to ground contact,
wherein during the maneuvering process with the large wheel deflection, the wheel load at a first wheel pair, which comprises a left/right front wheel and a right/left rear wheel arranged diagonally with respect thereto, is reduced selectively compared to a second wheel pair, which comprises a right/left front wheel and a left/right rear wheel arranged diagonally with respect thereto, in order to reduce the friction at one of the two front wheels during the maneuvering.

2. The method as claimed in claim 1, wherein the chassis is interlocked diagonally in order to generate cross-load shifting.

3. The method as claimed in claim 1, wherein during the maneuvering a front wheel on the inside of a bend is forced by the wheel load, which is reduced compared to a front wheel on the outside of the bend, onto a circular path which is concentric with respect to a circular path of the front wheel on the outside of the bend.

4. The method as claimed in claim 3, wherein during the maneuvering a turning circle of the motor vehicle is reduced significantly owing to the circular path of the front wheel on the inside of the bend.

5. The method as claimed in claim 3, wherein during the maneuvering a real deflection angle of the front wheel on the inside of the bend is reduced compared to a pre-determined deflection angle at which the front wheels describe concentric circular paths in the case of an Ackermann percentage of one hundred percent.

6. The method as claimed in claim 3, wherein the active chassis system is actuated in such a way that the chassis is interlocked and the wheel load of the second diagonal wheel pair is increased in order to reduce the wheel load of the first diagonal wheel pair.

7. An active chassis system for operating a motor vehicle according to a method as claimed in claim 1.

8. A computer program product having a program code for carrying out a method as claimed in claim 1.

9. A control unit for controlling the active chassis system with the computer program product as claimed in claim 8.

10. A motor vehicle having an active chassis system as claimed in claim 7.

11. A motor vehicle having the control unit as claimed in claim 9.
